(19) United States
(12) Patent Application Publication
(10) Pub. No.: US 2020/0079301 A1
(43) Pub. Date: Mar. 12, 2020

(54) HOLDING STRUCTURE FOR PROTECTION MEMBER OF WIRE HARNESS

(71) Applicant: SUMITOMO WIRING SYSTEMS, LTD., Yokkaichi-shi, Mie (JP)

(72) Inventor: Masahiro HAGI, Yokkaichi-shi (JP)

(73) Assignee: SUMITOMO WIRING SYSTEMS, LTD., Yokkaichi-shi, Mie (JP)

(21) Appl. No.: 16/465,942

(22) PCT Filed: Dec. 5, 2017
(86) PCT No.: PCT/JP2017/043572

§ 371 Date: May 31, 2019

(30) Foreign Application Priority Data
Dec. 19, 2016 (JP) 2016-245811

(51) Int. Cl. B60R 16/02; H02G 3/04

(52) U.S. Cl. CPC B60R 16/0215; H02G 3/0468

(57) ABSTRACT

A holding structure that includes a high-voltage wire that is to be electrically connected to a vehicle-mounted high-voltage battery; a cover that is formed of reinforcement fibers that have insulating properties, and that has a tubular shape covering an outer circumference of the high-voltage wire; and a pipe that includes a bent portion, and into which the high-voltage wire covered with the cover is inserted, wherein: the high-voltage wire includes a bent portion insertion part, and the high-voltage wire is inserted into the pipe such that the bent portion insertion part passes on an inner side of the bent portion of the pipe and is biased toward an inner surface of the bent portion, and the cover is sandwiched between the inner surface of the bent portion and the bent portion insertion part of the high-voltage wire.

This application is the U.S. National Phase of PCT/JP2017/043572 filed Dec. 5, 2017, which claims priority from JP 2016-245811 filed Dec. 19, 2016, the entire disclosure of which is incorporated herein by reference.

### BACKGROUND

The present disclosure relates to a holding structure for a protection member of a vehicle-mounted wire harness.

Conventionally, as described in JP 2016-63557A, for example, a vehicle such as a hybrid car or an electric automobile includes a motor serving as a motive power source for traveling of the vehicle, an inverter connected to the motor, and a high-voltage battery that supplies power to the inverter, and the inverter and the high-voltage battery are connected to each other by a wire harness including two plus and minus high-voltage wires.

### SUMMARY

For the above-described vehicle in which a device is connected to a high-voltage battery, there is concern that a short circuit between the two plus and minus high-voltage wires may be caused by an impact at the time of collision. Therefore, the present inventor has devised a configuration in which the outer circumference of the insulating coating of a high-voltage wire is covered with a protection member formed by braiding reinforcement fibers that have insulating properties. However, the issue of how the protection member is to be held still remains.

An exemplary aspect of the disclosure provides a holding structure capable of suitably holding a protection member that protects a high-voltage wire of a wire harness.

A holding structure, according to an exemplary aspect, includes a high-voltage wire that is to be electrically connected to a vehicle-mounted high-voltage battery; a cover that is formed of reinforcement fibers that have insulating properties, and that has a tubular shape covering an outer circumference of the high-voltage wire; and a pipe that includes a bent portion, and into which the high-voltage wire covered with the cover is inserted, wherein: the high-voltage wire includes a bent portion insertion part, and the high-voltage wire is inserted into the pipe such that the bent portion insertion part passes on an inner side of the bent portion of the pipe and is biased toward an inner surface of the bent portion, and the cover is sandwiched between the inner surface of the bent portion and the bent portion insertion part of the high-voltage wire.

With this configuration, the cover is sandwiched between the inner surface of the pipe and the high-voltage wire in the bent portion, thus making it possible to hold the cover without using adhesive tape or the like to fix the cover to the high-voltage wire.

In the above-described holding structure, the bent portion insertion part of the high-voltage wire is biased to an inner side of a bend of the bent portion of the pipe, and the cover is sandwiched between the bent portion insertion part and a bend inner side-inner surface of the bent portion, or the bent portion insertion part of the high-voltage wire is biased to an outer side of the bend of the bent portion of the pipe, and the cover is sandwiched between the bent portion insertion part and a bend outer side-inner surface of the bent portion. [0008]

With this configuration, it is possible to adjust the force for biasing the high-voltage wire to the inner surface of the bent portion, i.e., the sandwiching force of the cover, by adjusting the overall length of the high-voltage wire, thus making it possible to suitably hold the cover.

In the above-described holding structure, the pipe includes a plurality of the bent portions, which includes the bent portion, and the cover is sandwiched between a respective bent portion insertion part of the high-voltage wire and a respective inner surface of a respective bent portion in at least two or more of the bent portions.

With this configuration, the cover is sandwiched at at least two or more of the bent portions of the pipe, thus making it possible to more stably hold the cover.

In the above-described holding structure, the pipe is a metal pipe.

With this configuration, the cover can be suitably sandwiched between the inner surface of the metal pipe and the high-voltage wire. Since the outer circumference of the high-voltage wire is surrounded by the pipe formed by a metal pipe, the pipe can function as a shielding member of the high-voltage wire.

In the above-described holding structure, the reinforcement fibers of the cover are aramid fibers.

With this configuration, the cover that covers the outer circumference of the high-voltage wire is formed of aramid fibers, thus making it possible to suitably enhance the impact resistance of the high-voltage wire.

With the holding structures according to several modes of the present disclosure, it is possible to suitably hold a cover of a high-voltage wire formed by braiding reinforcement fibers that have insulating properties. Other features and advantages of the present disclosure will be apparent from the following description taken in conjunction with the drawings showing examples of the technical concept of the present disclosure.

### BRIEF DESCRIPTION OF THE DRAWINGS

FIG. 1 is a diagram showing a schematic configuration of a wire harness according to an embodiment.

FIG. 2 is a cross-sectional view taken along the line 2-2 in FIG. 1.

FIG. 3 is a perspective view showing a schematic configuration of a plus-side high-voltage wire according to the embodiment.

### DETAILED DESCRIPTION OF EMBODIMENTS

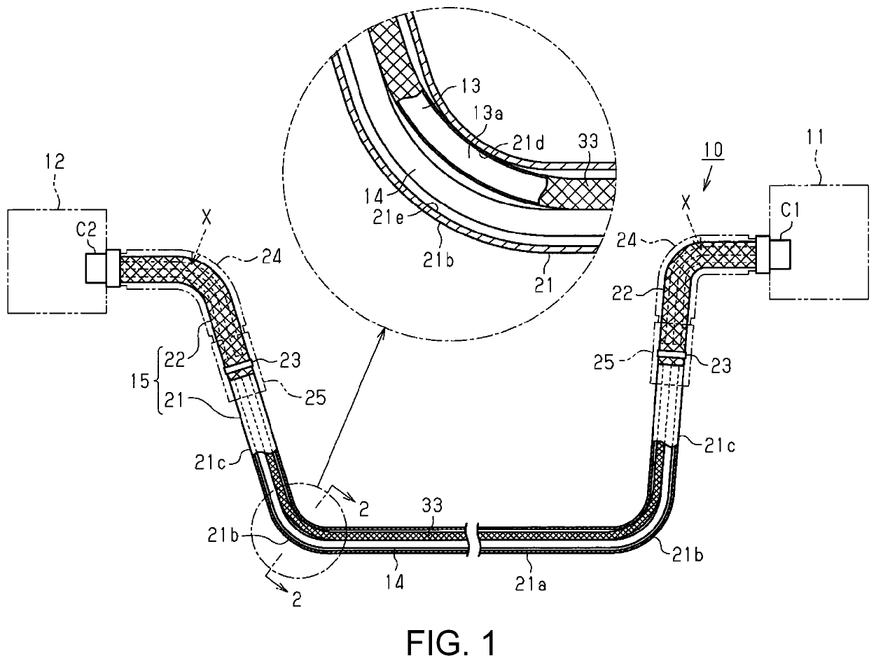

Hereinafter, an embodiment of a holding structure for a protection member (i.e., cover) of a wire harness will be described with reference to FIGS. 1 to 3. For the sake of convenience, part of the configuration may be exaggerated or simplified in the drawings. In addition, the dimensional ratios of the components may be different from the actual ratios.

As shown in FIG. 1, a wire harness 10 according to the present embodiment is routed in a hybrid car, an electric automobile, or the like so as to pass under the floor of the vehicle in order to connect, for example, a high-voltage battery 11 installed at the rear of the vehicle and an inverter 12 installed at the front of the vehicle. The inverter 12 is connected to a wheel-driving motor (not shown) serving as a motive power source for traveling of the vehicle, generates AC power from the DC power of the high-voltage battery 11, and supplies the AC power to the motor. The high-voltage battery 11 is a battery capable of supplying a voltage of several hundreds of volts.

The wire harness 10 includes a plus-side high-voltage wire 13 and a minus-side high-voltage wire 14 that are to be respectively connected to the plus terminal and the minus terminal of the high-voltage battery 11, and a tubular electromagnetic shielding portion 15 that collectively surrounds the high-voltage wires 13 and 14. Each of the high-voltage wires 13 and 14 is a non-shielded wire that does not include a shielding structure, and can accommodate a high voltage and a large current. The high-voltage wires 13 and 14 are inserted into the electromagnetic shielding portion 15, and one end portion of each of the high-voltage wires 13 and 14 is connected to the high-voltage battery 11 via a connector C1, and the other end portion thereof is connected to the inverter 12 via a connector C2.

The electromagnetic shielding portion 15 has an overall elongated tubular shape. An intermediate portion of the electromagnetic shielding portion 15 in the length direction thereof is constituted by a metal pipe 21, and opposite end portions in the length direction, excluding the area constituted by the metal pipe 21, are each formed by a braided member 22.

The metal pipe 21 is made of an aluminum-based metal material, for example. The metal pipe 21 is to be routed passing under the floor of a vehicle, and is routed while being bent in a predetermined shape corresponding to the underfloor configuration. The metal pipe 21 according to the present embodiment includes a straight portion 21a that is routed under the floor of the vehicle in the front-rear direction of the vehicle, a bent portion 21b provided at each of the opposite ends of the straight portion 21a, and an upper extending portion 21c extending to the upper side of the vehicle from each of the bent portions 21b. The metal pipe 21 collectively shields the high-voltage wires 13 and 14 that are inserted thereinto, and protects the high-voltage wires 13 and 14 from flying stones or the like.

Each braided member 22 is a tubular member formed by braiding a plurality of bare metal wire strands. The braided members 22 are respectively coupled to the opposite end portions of the metal pipe 21 in the length direction using a coupling member 23 such as a crimp ring, and, thus, each of the braided members 22 is electrically conductively connected to the metal pipe 21. The outer circumference of each of the braided members 22 is surrounded by an exterior material 24 such as a corrugated tube. A rubber grommet 25 that prevents the entry of water by covering the outer circumference of the connection portion is attached to the connection portion between the metal pipe 21 and each of the braided members 22.

Each braided member 22 collectively surrounds the outer circumferences of the areas (extra-pipe areas X) of the high-voltage wires 13 and 14 that are drawn from an end portion of the metal pipe 21. Consequently, the extra-pipe areas X of the high-voltage wires 13 and 14 are shielded by the corresponding braided member 22.

Next, the configurations of the high-voltage wires 13 and 14 will be described.

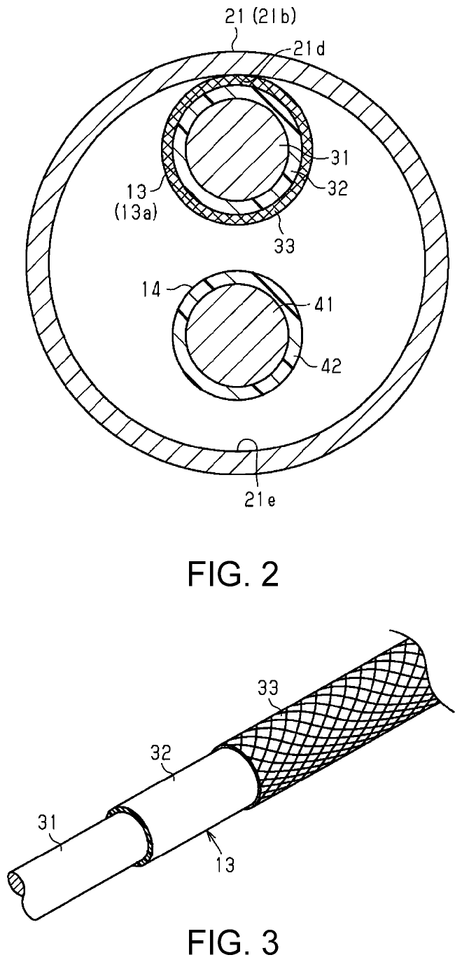

As shown in FIGS. 2 and 3, the plus-side high-voltage wire 13 is a coated wire in which a core wire 31 formed of a conductor is covered with an insulating coating 32 made of a resin material. The insulating coating 32 is formed on the outer circumferential surface of the core wire 31 through extrusion coating, and covers the outer circumferential surface of the core wire 31 in a closely attached state.

The outer circumference of the insulating coating 32 of the plus-side high-voltage wire 13 is surrounded by a tubular protection member 33 provided coaxially with the high-voltage wire 13. The protection member 33 is formed by braiding reinforcement fibers that have excellent insulating properties and shear resistance, and has flexibility. The protection member 33 according to the present embodiment has a length that covers substantially the entire length of the insulating coating 32.

Examples of the reinforcement fibers that form the protection member 33 include para-aramid fibers, polyarylate fibers, polyparaphenylene benzobisoxazole (PBO) fibers, polyethylene terephthalate (PET) fibers, ultrahigh-molecular-weight polyethylene fibers, polyetherimide (PEI) fibers, glass fibers, and ceramic fibers, and it is preferable to use one or more types of these fibers according to the physical properties required for the protection member 33. In the present embodiment, the protection member 33 is formed by one type of fiber, namely, para-aramid fibers.

As with the plus-side high-voltage wire 13, the minus-side high-voltage wire 14 is a coated wire including a core wire 41 formed of a conductor, and an insulating coating 42 formed on the outer circumferential surface of the core wire 41 through extrusion coating. The minus-side high-voltage wire 14 does not include the protection member 33, which is included in the plus-side high-voltage wire 13, and has a configuration in which the protection member 33 is removed from the plus-side high-voltage wire 13.

Next, the holding structure for the protection member 33 provided on the plus-side high-voltage wire 13 will be described.

As shown in FIG. 1, the overall length of the high-voltage wire 13 is set to be shorter than a reference length such that a bent portion insertion part 13a of the plus-side high-voltage wire 13 that passes on the inner side of the bent portion 21b of the metal pipe 21 is biased toward the inner surface (bend inner side-inner surface 21d) on the inner side of the bend of the bent portion 21b. Also, the protection member 33 covering the insulating coating 32 of the plus-side high-voltage wire 13 is sandwiched in the radial direction of the metal pipe 21 between the bent portion insertion part 13a of the plus-side high-voltage wire 13 biased to the inner side of the bend and the bend inner side-inner surface 21d of the bent portion 21b of the metal pipe 21 (see also FIG. 2). The wire harness 10 according to the present embodiment includes the above-described configuration for sandwiching the protection member 33 between the high-voltage wire 13 and the inner surface of the metal pipe 21 in each of the two bent portions 21b of the metal pipe 21. Note that, as shown in FIG. 2, the protection member 33 includes a first portion sandwiched between the bent portion insertion part 13a and the bend inner side-inner surface 21d of the metal pipe 21, and the protection member 33 may, in a cross-sectional view, not come into contact with a bend outer side-inner surface 21e of the metal pipe 21 that is located opposite to the bend inner side-inner surface 21d.

Next, the operations of the present embodiment will be described.

The plus-side high-voltage wire 13 has a configuration in which the core wire 31 and the insulating coating 32 are covered with the protection member 33 that is formed of reinforcement fibers, for example, made of para-aramid fibers and has excellent impact resistance (in particular, shear resistance). Accordingly, even if the metal pipe 21 is damaged due to an impact when the vehicle is in a collision, it is possible to prevent the core wires 31 and 41 of the plus-side high-voltage wire 13 and the minus-side high-voltage wire 14 from coming into direct contact with each other, or from being conductively connected to each other via any conductor such as a fractured piece of the metal pipe 21 or other vehicle components. Since the protection member 33 has insulating properties, it is possible to prevent the core wires 31 and 41 of the plus-side high-voltage wire 13 and the minus-side high-voltage wire 14 from being conductively connected to each other via the protection member 33.

Next, the effects of the present embodiment will be described.

(1) The high-voltage wire 13 is inserted into the metal pipe 21 such that the bent portion insertion part 13a that passes on the inner side of the bent portion 21b is biased toward the inner surface of the bent portion 21b. Also, the protection member 33 is sandwiched between the inner surface of the bent portion 21b and the bent portion insertion part 13a of the high-voltage wire 13. With this configuration, the protection member 33 is sandwiched between the inner surface of the metal pipe 21 and the high-voltage wire 13 at the bent portion 21b, thus making it possible to hold the protection member 33 without using adhesive tape or the like to fix the protection member 33 to the high-voltage wire 13.

(2) The bent portion insertion part 13a of the high-voltage wire 13 is biased to the inner side of the bend of the bent portion 21b of the metal pipe 21, and the protection member 33 is sandwiched between the bent portion insertion part 13a and the inner surface (bend inner side-inner surface 21d) on the inner side of the bend of the metal pipe 21. With this configuration, it is possible to adjust the force for biasing the high-voltage wire 13 to the inner surface of the bent portion 21b, i.e., the sandwiching force of the protection member 33, by adjusting the overall length of the high-voltage wire 13, thus making it possible to suitably hold the protection member 33.

(3) The metal pipe 21 includes two bent portions 21b, and the protection member 33 is sandwiched between the bent portion insertion part 13a of the high-voltage wire 13 and the inner surface of the bent portion 21b in each of the bent portions 21b. With this configuration, the protection member 33 is sandwiched at at least two bent portions 21b of the metal pipe 21, thus making it possible to more stably hold the protection member 33.

(4) The pipe member into which the high-voltage wire 13 covered with the protection member 33 is inserted is constituted by a metal pipe 21. With this configuration, the protection member 33 can be suitably sandwiched between the inner surface of the metal pipe 21 and the high-voltage wire 13. Since the outer circumference of the high-voltage wire 13 is surrounded by the metal pipe 21, the metal pipe 21 can function as a shielding member of the high-voltage wire 13.

(5) By using aramid fibers as the reinforcement fibers that form the protection member 33, it is possible to suitably enhance the impact resistance of the high-voltage wire 13. As a result, it is possible to suitably prevent a short circuit between the core wires 31 and 41 of the high-voltage wires 13 and 14.

Note that the above-described embodiment may be modified as follows.

In the above embodiment, the bent portion insertion part 13a of the high-voltage wire 13 is biased to the inner side of the bend of the bent portion 21b of the metal pipe 21, and the protection member 33 is sandwiched between the bent portion insertion part 13a and the bend inner side-inner surface 21d of the metal pipe 21. However, in addition to this, it is possible to adopt a configuration in which, for example, the bent portion insertion part 13a is biased to the outer side of the bend, and the protection member 33 is sandwiched between the bent portion insertion part 13a and the inner surface (bend outer side-inner surface 21e) on the outer side of the bend of the metal pipe 21.

In the above embodiment, the metal pipe 21 includes two bent portions 21b; however, the present disclosure is not limited thereto, and the metal pipe 21 may include one, or three or more bent portions. The structure for sandwiching the protection member 33 between the high-voltage wire 13 and the inner surface of the metal pipe 21 may be provided in at least one of the bent portions of the metal pipe 21.

The protection member 33 of the above embodiment is provided over substantially the entire length of the high-voltage wire 13 (insulating coating 32); however, the present disclosure is not limited thereto, and the protection member 33 may be provided in a portion in the length direction of the high-voltage wire 13 in a configuration in which the bent portion insertion part 13a is present.

In the above embodiment, only the plus-side high-voltage wire 13 of each of the high-voltage wires 13 and 14 is provided with the protection member 33; however, the present disclosure is not limited thereto, and only the minus-side high-voltage wire 14, or each of the high-voltage wires 13 and 14 may be provided with the protection member 33. With a configuration in which each of the high-voltage wires 13 and 14 is provided with the protection member 33, the impact resistance of each of the high-voltage wires 13 and 14 can be enhanced. As a result, it is possible to more suitably prevent a short circuit between the core wires 31 and 41 of the high-voltage wires 13 and 14.

In the above embodiment, in order to enhance the impact resistance of the plus-side high-voltage wire 13, a covering member such as a resin tube (e.g., polyethylene) that covers the outer circumference of the protection member 33 may be provided along the entire or part of the length of the protection member 33. Note that, when such a covering member is provided at the bent portion insertion part 13a of the plus-side high-voltage wire 13, the covering member is interposed between the protection member 33 and the inner surface of the bent portion 21b. However, the sandwiching of the protection member 33 by biasing the high-voltage wire 13 can be achieved.

In the above embodiment, the metal pipe 21 is used as the pipe member into which the high-voltage wire 13 is inserted, and that holds the protection member 33 covering the outer circumference of the high-voltage wire 13; however, the material of the pipe member is not limited to a metal, and may be changed to a synthetic resin, for example.

The wire harness 10 according to the above embodiment has a configuration in which two wires, namely, the plus-side high-voltage wire 13 and the minus-side high-voltage wire 14, are inserted into the electromagnetic shielding portion 15; however, the configuration of a wire that is inserted into the electromagnetic shielding portion 15 may be changed as appropriate according to the configuration of the vehicle. For example, a low-voltage wire that connects a low-voltage battery to various low-voltage devices (e.g., a lamp and a car audio system) may be additionally provided as a wire that is inserted into the electromagnetic shielding portion 15.

The arrangement relationship between the high-voltage battery 11 and the inverter 12 in the vehicle is not limited to that described in the above embodiment, and may be changed as appropriate according to the configuration of the vehicle. In the above embodiment, the high-voltage battery 11 is connected to the inverter 12 via the high-voltage wires 13 and 14; however, the high-voltage battery 11 may be connected to a high-voltage device other than the inverter 12.

The above embodiment is applied to the wire harness 10 that connects the high-voltage battery 11 and the inverter 12. However, in addition to this, the present disclosure may also be applied to, for example, a wire harness that connects the inverter 12 and a wheel-driving motor.

The embodiments and the modifications described above may be combined as appropriate.

It will be apparent to those skilled in the art that the present disclosure may be embodied in other specific forms without departing from the technical concept of the disclosure. For example, the components described in the embodiments above (or one or more aspects thereof) may be partly omitted and/or combined.

1. A holding structure, comprising:
a high-voltage wire that is to be electrically connected to a vehicle-mounted high-voltage battery;
a cover that is formed of reinforcement fibers that have insulating properties, and that has a tubular shape covering an outer circumference of the high-voltage wire; and
a pipe that includes a bent portion, and into which the high-voltage wire covered with the cover is inserted, wherein:
the high-voltage wire includes a bent portion insertion part, and the high-voltage wire is inserted into the pipe such that the bent portion insertion part passes on an inner side of the bent portion of the pipe and is biased toward an inner surface of the bent portion, and
the cover is sandwiched between the inner surface of the bent portion and the bent portion insertion part of the high-voltage wire.

2. The holding structure according to claim 1, wherein:
the bent portion insertion part of the high-voltage wire is biased to an inner side of a bend of the bent portion of the pipe, and the cover is sandwiched between the bent portion insertion part and a bend inner side-inner surface of the bent portion, or
the bent portion insertion part of the high-voltage wire is biased to an outer side of the bend of the bent portion of the pipe, and the cover is sandwiched between the bent portion insertion part and a bend outer side-inner surface of the bent portion.

3. The holding structure according to claim 1, wherein:
the pipe includes a plurality of the bent portions, which includes the bent portion, and
the cover is sandwiched between a respective bent portion insertion part of the high-voltage wire and a respective inner surface of a respective bent portion in at least two or more of the bent portions.

4. The holding structure according to claim 1, wherein the pipe is a metal pipe.

5. The holding structure according to claim 1, wherein the reinforcement fibers of the cover are aramid fibers.
